(19) United States
(12) Patent Application Publication
(10) Pub. No.: US 2004/0031400 A1
(43) Pub. Date: Feb. 19, 2004

(54) Device for deboning meat slabs for cutlets

(76) Inventor: Ulrich Merkle, Stuttgart (DE)

Correspondence Address: Felix J D'Ambrosio, Jones Tullar & Cooper, P O Box 2266, Eads Station, Arlington, VA, 22202, US

(21) Appl. No.: 10/239,852

(22) PCT Filed: Jun. 1, 2001
(86) PCT No.: PCT/EP01/06235

(30) Foreign Application Priority Data
Jul. 28, 2000 (DE) 100 37 300.3

(51) Int. Cl. A23N 1/00

(52) U.S. Cl. 99/537

(57) ABSTRACT

The invention relates to a device for deboning meat slabs for cutlets. The inventive device comprises a base plate (5) and a lateral guiding plate (8) for the meat slab, said base plate (5) and lateral guiding plate (8) forming a removable elbow element (20).

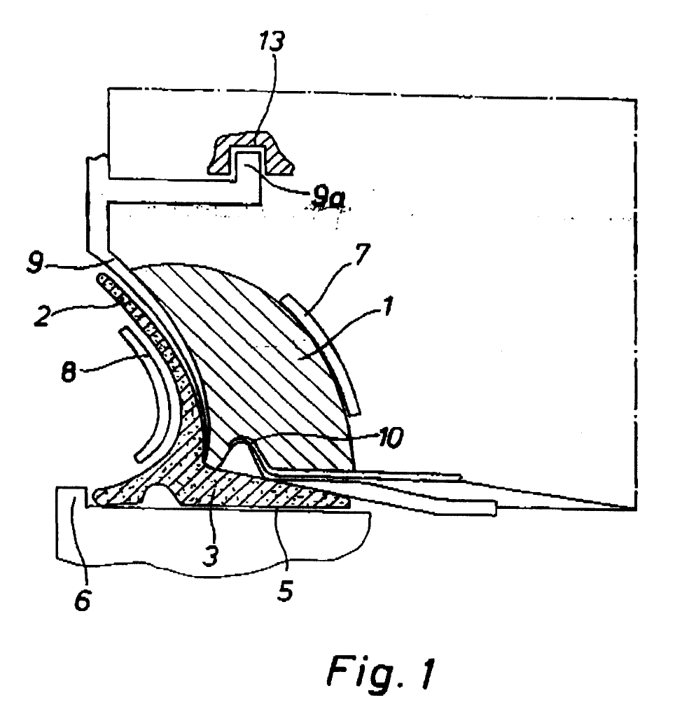

The invention is based on a prior art as defined by German Utility Model DE 299 10 490 U1. This prior art is shown in FIG. 1.

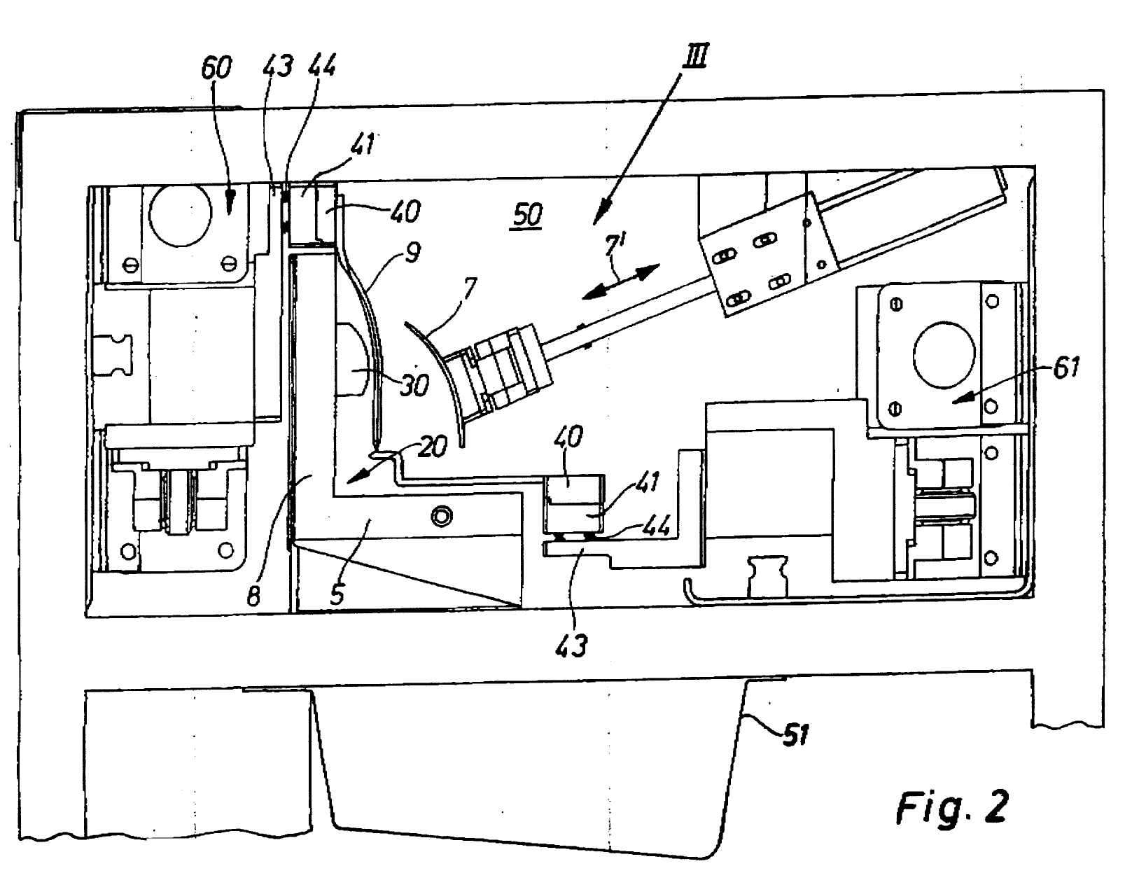

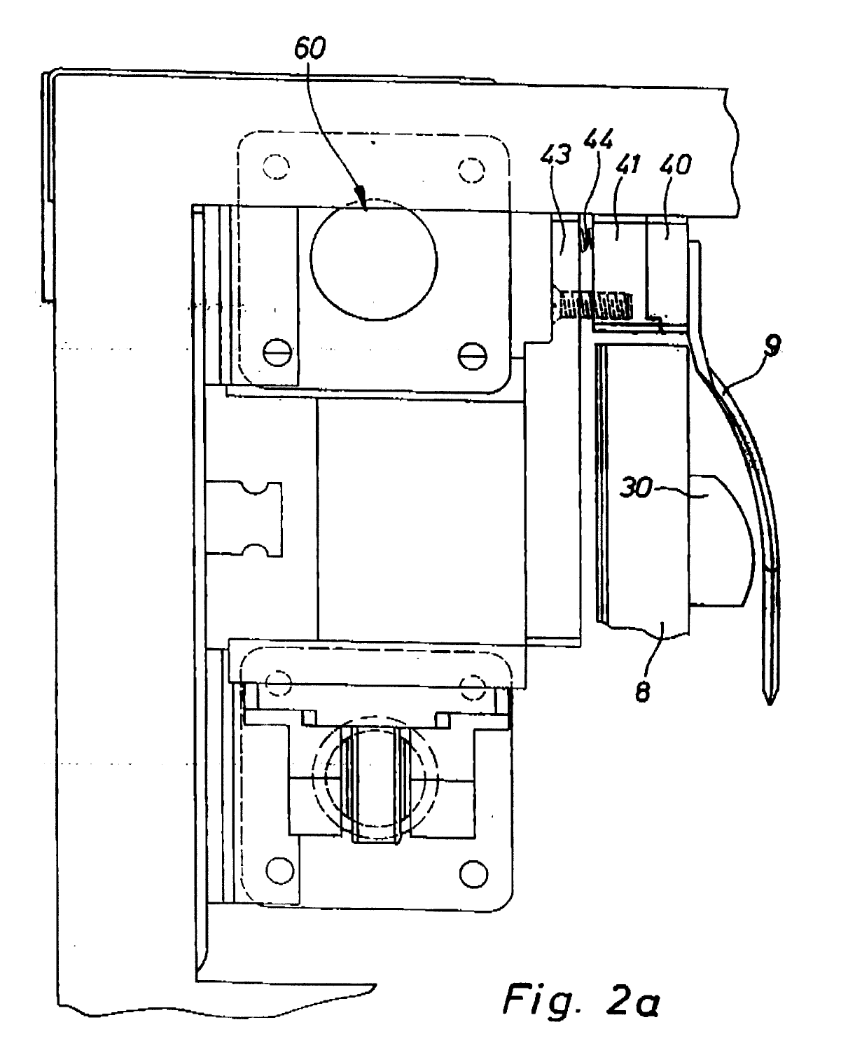

The device shown in FIG. 1 serves to peel a meat slab 1 away from the ribs 2 and backbones 3 of some part of an animal. This is done with the aid of blades 9 and 10, which are guided along the ribs and the backbones of the meat slab in one direction, extending essentially perpendicular to the plane of the drawing, by a linear drive mechanism (not visible in FIG. 1). The meat slab rests on a base plate 5 and is fixed in its position by a lateral stop 6 and a lateral guiding plate 8, against which it is pressed by a contact-pressure plate 7. This is correspondingly adjustable and fixable by suitable devices (not shown). During the longitudinal motion of the meat slab (perpendicular to the plane of the drawing), the blade 9 is guided, by means of the provision that a guide part 9a connected to it is guided in a blade guide 13, whose course is determined such that the cut is made as close as possible to the natural course of the parting plane between the ribs 2 and the meat slab 1 (see DE 299 10 490 U1, FIG. 2).

The object of the invention is to simplify and improve the device shown. A design which makes it possible for the parts with which the meat slab comes into contact in the deboning to be replaced and cleaned simply, is considered to be a simplification. At the same time, it should be assured that even with different animal parts, dictated by the natural constitution of the animals slaughtered, the meat slab will be cut away as exactly as possible, so that as nearly as possible, all the meat can be used.

This object is attained with the means recited in the body of claim 1. Advantageous refinements are defined by the dependent claims.

Below, one exemplary embodiment of the invention is described in further detail in conjunction with the accompanying drawings. These show:

FIG. 2, schematically, one exemplary embodiment, in the direction of the arrows II-II in FIG. 3;

FIG. 2a, a detail of FIG. 2;

FIG. 3, a portion of the exemplary embodiment seen in the direction of the arrow III in FIG. 2;

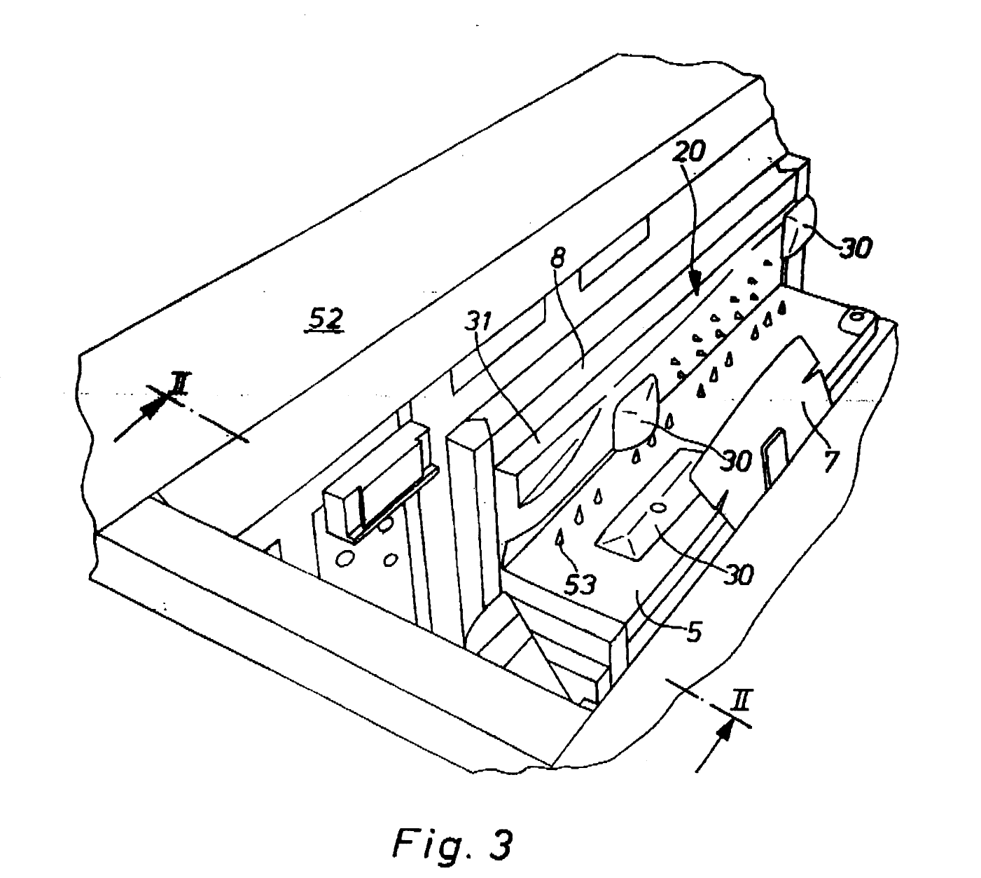

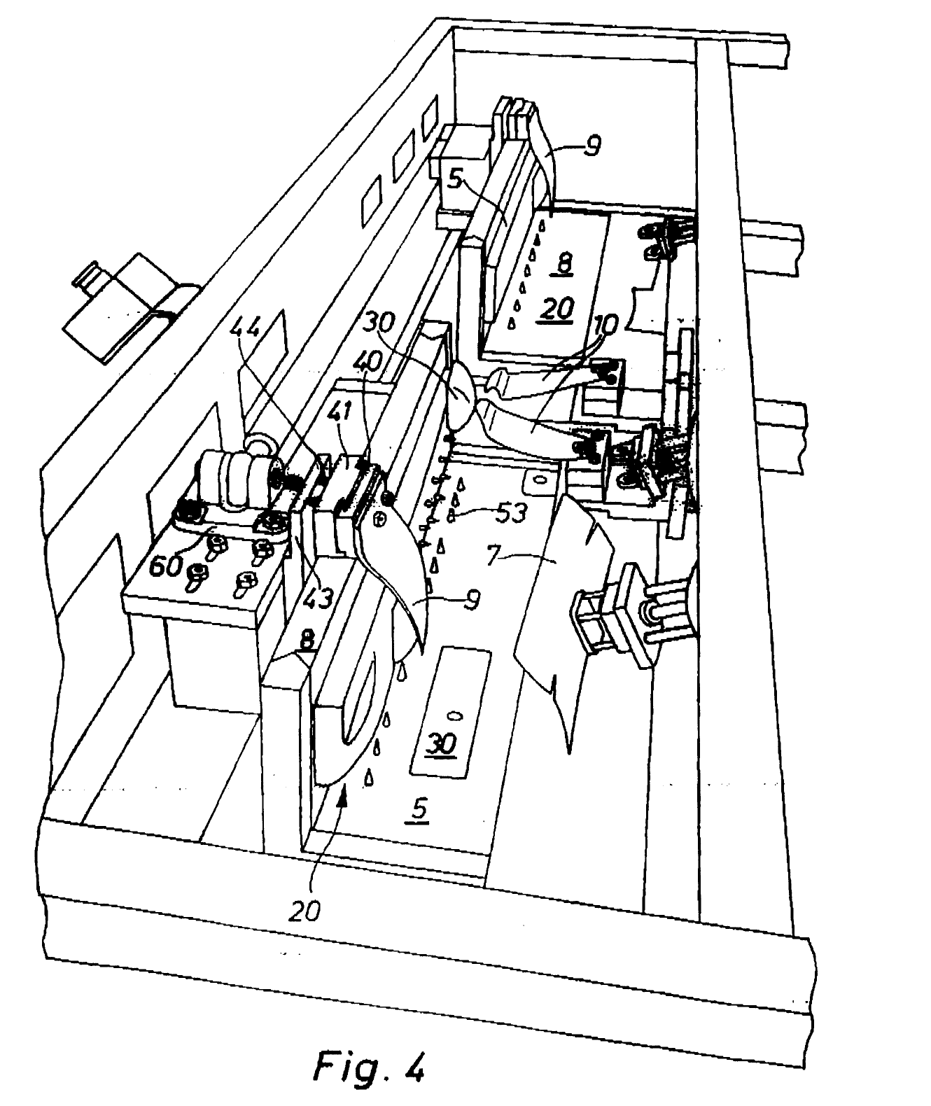

FIG. 4, a front view obliquely from above of the exemplary embodiment of FIG. 2;

FIG. 5, a view similar to that of FIG. 4, but from the back, so that the elbow elements 20 are no longer on the left (as in FIG. 4) but on the right;

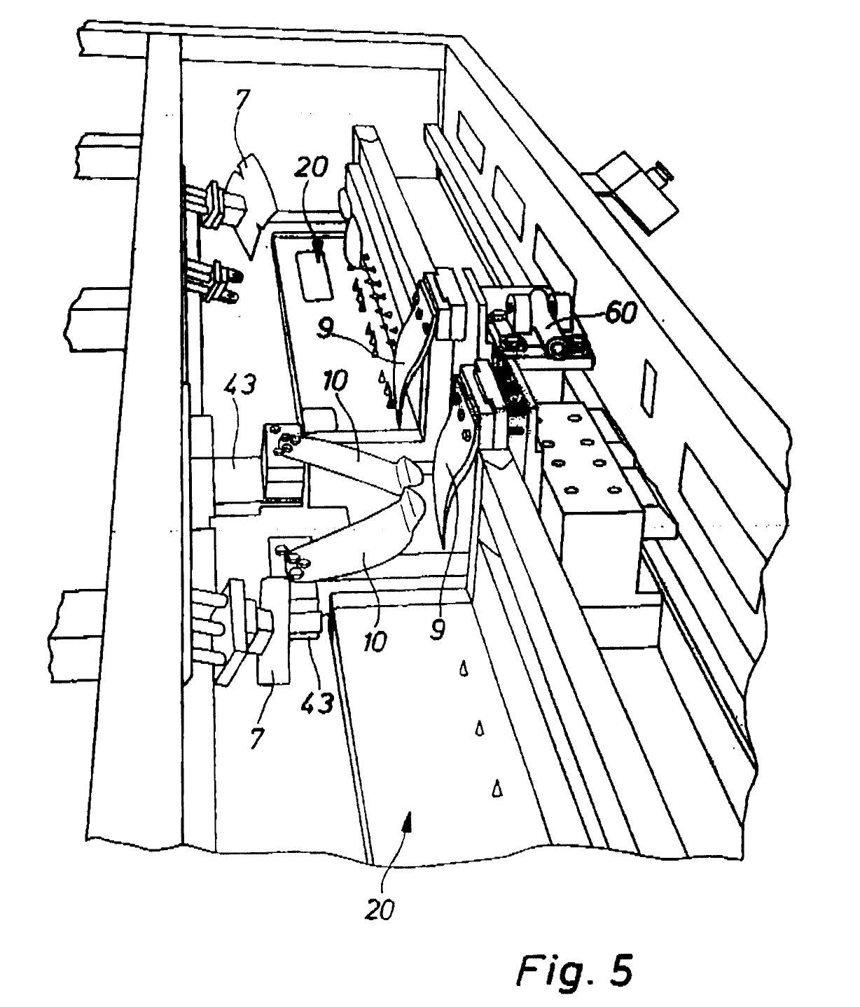

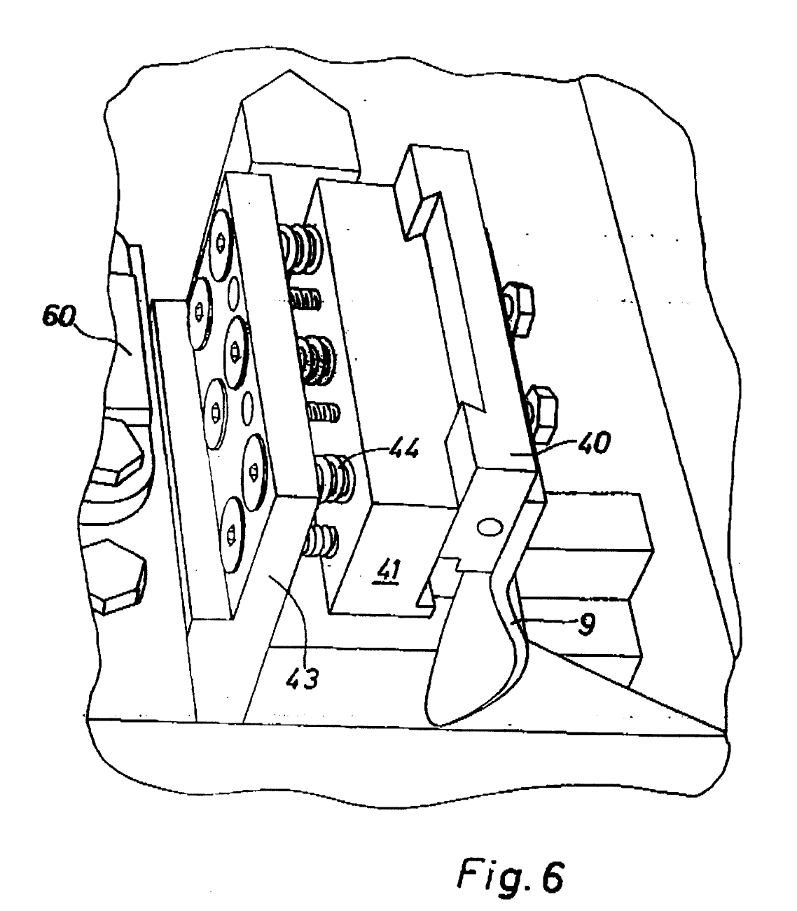

FIG. 6, the suspension of the knife 9;

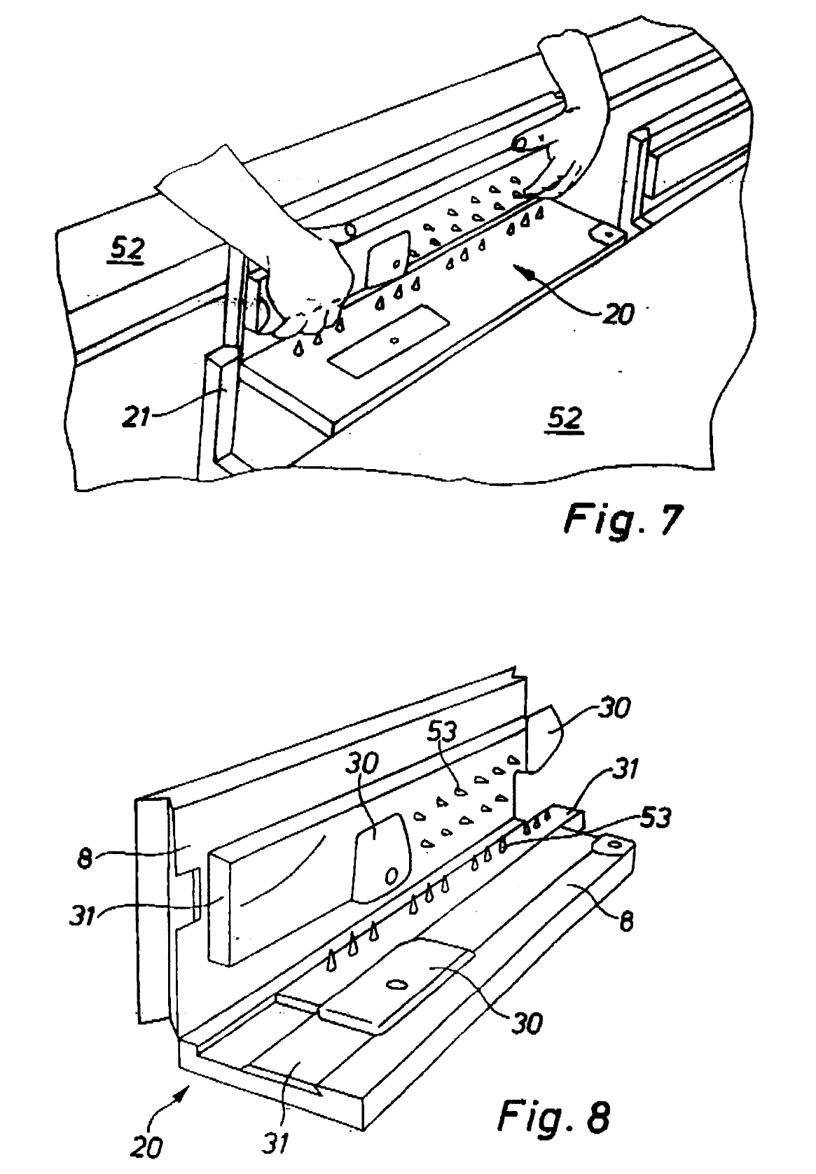

FIG. 7, the removal of the elbow element 20;

FIG. 8, the elbow element 20.

FIG. 1 is a section crosswise to the longitudinal direction; the meat slab 1 itself is not shown. However, its location can easily be imagined, because it is inserted in such a way that—analogously to FIG. 1—the backbones 3 rest on the base plate 5, and the ribs 2 rest laterally on the guiding plate 8, and the meat slab is pressed against these two faces by the contact-pressure plate 7. The contact-pressure plate 7 can be adjusted and fixed pneumatically in the direction of the double arrow 7′ shown. The deboning of the meat slab from the ribs 2 is done by means of the cutting blade 9 and from the backbones 3 by means of the cutting blade 10; the cutting blade 9 is disposed essentially vertically, and the cutting blade 10 is disposed essentially horizontally. Both blades can be displaced perpendicular to the plane of the drawing by means of linear drive mechanisms 60, 61.

The lateral guiding plate 8 and the base plate 5 together integrally form a 90° elbow element 20, which as shown in FIG. 9 can be removed at the top from a mount 21. The operation of removal is shown in FIG. 8.

Adaptation pieces 30 are mounted on to the lateral base plate 8 (see also FIGS. 3 and 9), which together with the cross section, which also varies longitudinally, of the guiding plate 8 produce a profile that corresponds to the natural anatomical course of the meat slab (with backbone and ribs). By suitable design and positioning of these adaptation elements 30, it is possible upon a linear motion of the cutting blade 9 to make the most exact possible cut along the bone of the ribs 2. As can be seen from FIG. 9, the adaptation elements 30 are disposed on a strip 31, which is displaceable in the guiding plate 8 with the aid of a dovetail guide.

Suitable adaptation elements 32 are also provided on the base plate 5 (see FIGS. 3 and 9). Since the strips 31 are displaceable and thus replaceable in the guiding plate 8 and/or in the base plate 5, and since the entire elbow element 20 is easily removable from the mount 21, the entire base region can easily be removed and cleaned quickly.

A further characteristic of the invention is the resilient suspension of the blades 9 and 10, respectively. The blade 9, as can be seen from FIG. 2, rests on a block 40. This block, as can be seen from FIG. 7, is supported in a way that is adjustable in height and fixable on a block 41, with the aid of a dovetail guide 42. The block 42 is in turn supported on a plate 43 in such a way that the blocks 40, 41 and with them the blade 9 are pressed into the position shown by compression springs 44, but compared to this position are pivotable to a limited extent in all directions, so that they always rest on the bones of the rib and backbone. The compression springs 44 are disposed between the plate 43 and the block 41. Screws 45 are screwed through the plate 43 and the block 41 but are movable in the holes in the plate 43. This assures that all the flesh will actually be cut away from the bone.

The blade 10 is supported analogously. The blades 9 and 10 have a certain adapted shape, visible in FIG. 2, and are ground in a special way.

As can be seen from FIG. 5, two elbow elements 20 are disposed linearly one after the other in the machine frame. Each elbow element is assigned one blade 9 and one blade 10. The plates 34 for the two blades 10 and for the two blades 9 can be moved simultaneously outward from the position shown in FIG. 5 by means of the linear drive mechanisms 60, 61.

In summary, the advantages can accordingly be described as follows: The blades 9, 10 are disposed “resiliently”, so that during their longitudinal motion they can adapt to the rib bones. At the same time, the bases for the meat slab are designed three-dimensionally by means of fittings in the form of adaptation elements 30, 32; that is, relative to the horizontal and vertical faces, they are determined experimentally such that they are essentially the same for each group of types of cutlet (depending on the type of animal, and its age and weight), so that in the linear motion the blades will cut along the bone.

The bases form a 90° elbow element 20 made of plastic approved for use with foodstuffs, and the elbow element is interchangeable, i.e. replaceable. Not only does this replaceability make for better cleaning; it also allows fast replacement of suitably differently designed elbow elements 20, adapted to various experimentally determined shapes of meat slabs.

The design in hygienic terms can be seen in FIG. 3. The arrangement is located in a trench 50, into which the meat slabs are introduced from above and from which they can also be removed again at the top, and in which the blades 9, 10 are linearly displaceable. At the bottom, this trench is open to a tub 51 (see FIG. 2), which receives waste that drops into it and has outlet openings. Thus the entire arrangement is also easy to clean from above using a water hose. The covering of the regions on both sides of the trench is accomplished by means of suitably large-area shielding plates 52.

List of Reference Numerals

| | |
|---|---|
| 1 | Meat slab |
| 2 | Rib |
| 3 | Backbone |
| 5 | Base plate |
| 6 | Lateral stop |
| 7 | Contact-pressure plate |
| 7′ | Double arrow |
| 8 | Lateral guiding plate |
| 9 | Cutting blade |
| 9a | Guide part |
| 10 | Cutting blade |
| 13 | Blade guide |
| 20 | Elbow element |
| 21 | Mount |
| 30 | Adaptation element |
| 31 | Strip |
| 32 | Adaptation element |
| 40 | Block |
| 41 | Block |
| 42 | Dovetail guide |
| 43 | Plate |
| 44 | Spring |
| 45 | Screw |
| 50 | Trench |
| 51 | Tub |
| 52 | Shielding plate |
| 53 | Mounting pin |
| 60, 61 | Linear drive mechanisms |

1. A device for deboning meat slabs for cutlets, having a base plate and a lateral bearing plate for the meat slab, and having blades (9, 10) displaceable linearly along the meat slab, characterized in that the base plate (5) and the lateral bearing plate (8) are part of an elbow element (20) which can be removed at the top from a mount (21).

2. The device of claim 1, characterized in that adaptation elements (30, 32) are disposed, preferably adjustably, on the base plate (5) and/or on the lateral guiding plate (8) for three-dimensional adaptation to the shape of the meat slab.

3. The device of claim 2, characterized in that the adaptation elements (30, 32) are adjustable and replaceable by means of dovetail guides.

4. The device of one of claims 1-3, characterized in that for mounting the meat slab, mounting pins (53) are disposed in the faces (5, 8) of the bearing plate (5) and/or of the lateral guiding plate (8).

5. The device of one of claims 1-4, characterized in that the blades (9, 10) are each disposed on a mounting part (40), which is retained pivotably, relative to a further mounting part (43) connected to the linear drive mechanism of these blades, in one and preferably more [noun missing] counter to the force of springs (44), for adaptation to the natural course of the meat slab.

6. The device of one of claims 1-5, characterized in that the faces of the device on both sides of a trench (50) are covered by shielding plates (52), and that the elbow elements (20) with the associated linear drive mechanisms (60, 61) for the blades (9, 10) are disposed in the trench, and that this trench opens at the bottom into a tub (51).
